(19) United States
(12) Patent Application Publication
(10) Pub. No.: US 2008/0129860 A1
(43) Pub. Date: Jun. 5, 2008

(54) Digital camera

(76) Inventor: Kenji Arakawa, Kyoto (JP)

Correspondence Address: MCDERMOTT WILL & EMERY LLP, 600 13TH STREET, NW, WASHINGTON, DC, 20005-3096, US

(21) Appl. No.: 11/979,404

(22) Filed: Nov. 2, 2007

(30) Foreign Application Priority Data
Nov. 2, 2006 (JP) 2006-299372

(51) Int. Cl. H04N 5/235

(52) U.S. Cl. 348/363; 348/E05.035

(57) ABSTRACT

A digital camera including: an imaging device having a function to control a quantity of transmitted light of an imaging optical system and a function to subject the transmitted light to photoelectric conversion to generate a video signal; an area specifying portion specifying an area to control; an image data conversion portion converting the video signal generated by the imaging device to image data including a luminance signal and a color difference signal and outputting the image data; a luminance signal detection portion detecting the luminance signal from the video signal or the image data; a gradation assignment portion giving an instruction to the image data conversion portion on assignment of gradation based on information detected by the luminance signal detection portion; and a control device controlling the imaging device, the area specifying portion, the gradation assignment portion, the image data conversion portion, and the luminance signal detection portion. The image data conversion portion performs the conversion based on the instruction on assignment of gradation from the gradation assignment portion.

This non-provisional application claims priority based on Patent Application No. 2006-299372 filed in Japan on Nov. 2, 2006, the entire contents of which are hereby incorporated by reference.

### BACKGROUND OF THE INVENTION

1. Technical Field

The present invention relates to a digital camera equipped with a solid-state imaging device (CCD, CMOS and the like) having a photoelectric conversion function.

2. Related Art

In recent years, through popularization of digital cameras (digital still cameras, digital video cameras, mobile cameras and the like), digitalization of photographic imagery can be done readily. Particularly, there are increasing opportunities of treating photographic imagery as digital image data on personal computers.

Further, through popularization of application software which can correct or process an image, a user can freely perform image processing on the personal computer. For example, correction processing to brighten an image photographed darkly and processing treatment to make wrinkles inconspicuous by applying LPF to a flesh-color area can be exemplified.

From such background, there is a need for an image processing technique that eliminates the need for correction and processing treatment of imagery during shooting.

In recent years, it has been becoming possible to detect a person's face from an image and the accuracy of the detection is improving as well. As an effect of facial detection, correction of luminance of a facial portion in correcting backlight imagery is considered effective.

In view of this, when making an album or a list of photos of individual faces, there is a need for improved visibility by shooting and performing image processing so as to assure uniform levels of luminance (brightness) and gradation under different photographic conditions.

For example, Japanese Unexamined Patent Application Publication No. 2000-354196 discloses a technique of providing proper exposure of a photographic subject through optimum exposure control. Japanese Unexamined Patent Application Publication No. 2006-18465 discloses a technique of extracting a facial area and changing its level of luminance.

### SUMMARY OF THE INVENTION

In prior art techniques, proper exposure and diaphragm control are conducted according to photographic conditions. But since there are no uniform standards regarding the level of luminance signal of the photographic subject, the brightness of the photographic subject varies under different photographic conditions. Further, even if the same level of brightness is set with respect to different photographic conditions, assignment of gradation is provided to the entire surface of the image so that the gradations of the photographic subjects differ from each other.

In the digital camera of the present invention, exposure adjustment, diaphragm control, gain control, and gradation correction are performed such that the luminance level of a specified area (flesh-color area, AF area, facial area by facial recognition and the like) is on a uniform level regardless of the photographic conditions. While the gradation of an area whose luminance level is to be changed is maintained, the luminance level of the area is changed (the gamma characteristic is changed), thereby retaining high-definition of the specified area. When an album shooting mode is entered by means of the mode dial, a frame of a face is shown by OSD. By placing a face in that frame and shooting, the size of the face is fixed. Further, the above-mentioned processing is applied to that area.

According to the digital camera of the present invention, since the luminance level of the photographic subject remains constant even if the photographic conditions differ, it becomes easier to make a comparison of photographic subjects (faces, upper halves of bodies, food samples and the like). Further, when carrying out gain control, the gradation in the vicinity of the photographic subject is retained, and hence, the high-definition of the photographic subject is retained, thereby improving recognition of the photographic subject. Still further, the frame is shown by the OSD, and by placing the photographic subject in that frame and shooting it, the shooting can be performed at a constant size regardless of the size of the photographic subject and the photographic conditions. Moreover, it becomes easier to compare photographic subjects.

### BRIEF DESCRIPTION OF THE DRAWINGS

FIG. 1 is a block diagram of a digital camera according to a first embodiment;

FIG. 2 is a schematic diagram of gradation assignment corresponding to luminance signal levels;

FIG. 3 is an example of the frequency of appearance of luminance corresponding to FIG. 2;

FIG. 4 is a schematic diagram of gradation assignment after correcting gradation of a facial area in FIG. 2;

FIG. 5 is a schematic diagram of a targeted mean luminance;

FIG. 6 is a diagram of approximation concept of a gradation assignment curve;

FIG. 7A is an image prior to correction and FIG. 7B is an image after the correction;

FIG. 8A is an image of a picture, and FIG. 8B is a specified area (correction area);

FIG. 9A is an image of a picture, and FIG. 9B is a specified area (correction area);

FIG. 10 is a schematic diagram of threshold values of luminance signals;

FIG. 11 is a schematic diagram of processing for high luminance areas;

FIG. 12 is a schematic diagram of an area corrected by OSD overlapping;

FIG. 13 is a block diagram of a video signal adjustment portion performing complimentary primary color conversion;

FIG. 14 is a block diagram of a digital cameral according to a second embodiment;

FIG. 15A is an image of a picture using an AF area, and FIG. 8B is a correction area;

FIG. 16 is a block diagram of a digital camera according to a third embodiment;

FIG. 17 is a schematic diagram of the targeted minimum luminance;

FIG. 18 is a schematic diagram of the targeted maximum luminance;

FIG. 19 is a block diagram of a digital camera provided with an AE control portion;

FIG. 20 is a block diagram of a digital camera when detection of luminance signals is conducted with respect to image data; and

FIG. 21 is a schematic diagram when changing gradation assignment curves corresponding to the frequency of appearance of luminance in the facial area.

### DESCRIPTION OF THE PREFERRED EMBODIMENTS

With reference to the drawings, the embodiments of the present invention will be described as follows.

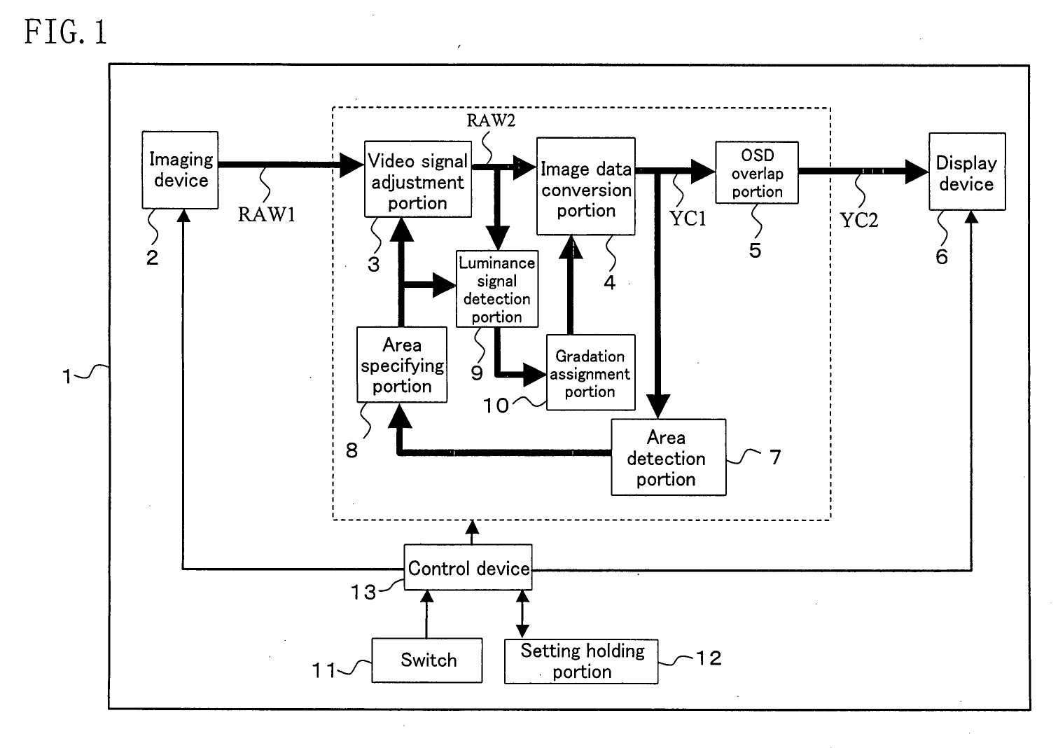

A construction of a digital camera according to a first embodiment is shown in FIG. 1. The digital camera 1 has an imaging device 2, a video signal adjustment portion 3, an image data conversion portion 4, an OSD overlap portion 5, a display device 6, an area detection portion 7, an area specifying portion 8, a luminance signal detection portion 9, a gradation assignment portion 10, a switch 11, a setting holding portion 12, and a control device 13.

The imaging device 2 converts light from a photographic subject by means of a solid-state imaging devices such as a CCD and a CMOS into a video signal RAW1 corresponding to R, G, B and outputs the video signal RAW1. The video signal adjustment portion 3 subjects each of the color components (R, G, B) of the video signal RAW1 from the imaging device 2 individually to gain adjustment, white balance adjustment, offset addition, scratch correction, and the like, and outputs RAW1 as an adjusted video signal RAW2. The image data conversion portion 4 converts the adjusted video signal RAW2 from the video signal adjustment portion 3 into image data YC1. The OSD overlap portion 5 overlaps an OSD (On Screen Display) on the image data YC1 and outputs it as an OSD overlap signal YC2. The display device 6 displays the OSD overlap signal YC2, e.g., a liquid crystal display or an organic EL display. The area detection portion 7 detects an area to control (a facial area, a flesh-color area, and the like) from the image data YC1. The area specifying portion 8 obtains information on the area detected by the area inspection portion 7, and specifies a gain adjustment area and the like in the video signal adjustment portion 3 based on the information. The luminance signal detection portion 9 detects a luminance signal from the adjusted video signal RAW2. The gradation assignment portion 10 gives an instruction to the image data conversion portion 4 on assignment of gradation based on the information detected by the luminance signal detection portion 9. The switch 11 gives instructions on selection of the shooting mode, shooting start, shooting end, ON/OFF of display output, change in gain adjustment value, and the like. The setting holding portion 12 holds settings (ISO sensitivity, diaphragm, exposure time and the like). The control device 13, upon switching of the shooting mode, reads a prior setting of the switched shooting mode from the setting holding portion 12 and controls each of the above-mentioned portions.

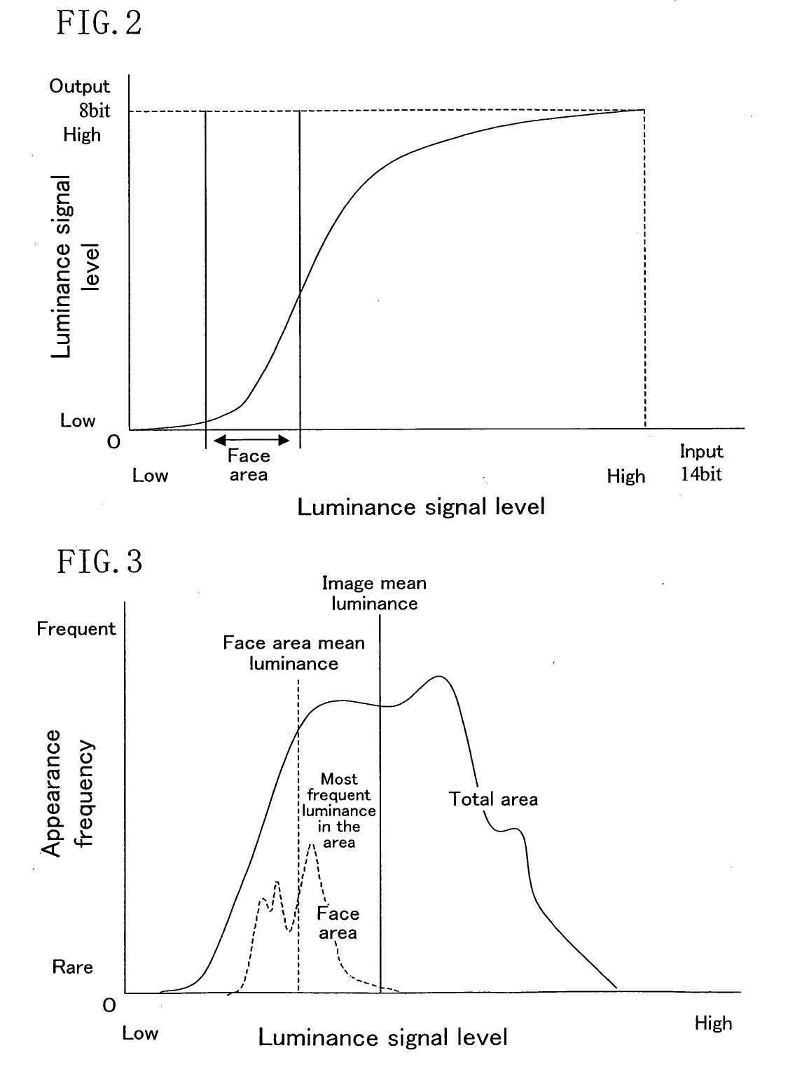

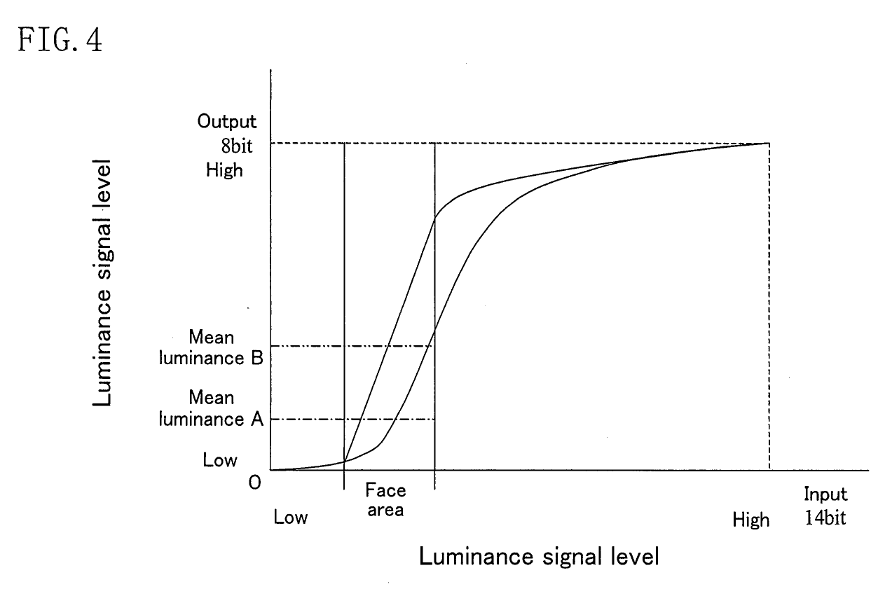

Since the gradation of the image data YC1 is generally less than the gradation of the video signal RAW1, as shown in FIG. 2, gradation assignment is changed according to the luminance signal level. FIG. 3 shows a graph indicating the luminance signal level and the frequency of appearance of an image whose specified area (facial area here) exists at low luminance as shown in FIG. 2. It is observed that the mean luminance of the facial area relative to the mean luminance of the overall image is low. Since this means that the facial area as it is will become dark and the gradation assignment as shown by the gradation assignment curve of FIG. 2 will be low, in the digital camera 1 of the present embodiment, the gradation assignment portion 10 changes the ratio of gradation assignment as shown in FIG. 4 so as to assign much gradation to the facial area. This increases the amount of change of output with respect to input of the facial area, thereby assigning much gradation to the facial area. Further, it is observed that the mean luminance of the facial area increases from the mean luminance A prior to the change to the mean luminance B after the change, thus making the image in the facial area bright.

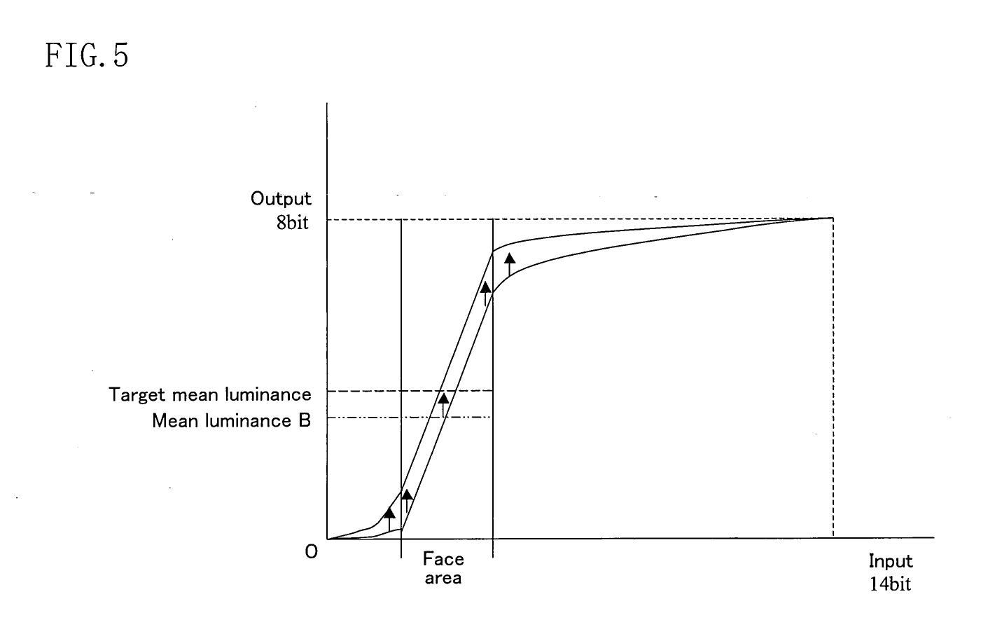

At this point, if a target mean luminance is set for the facial area (specified area), then, as shown in FIG. 5, by offsetting the specified area in the video signal adjustment portion 3, the mean luminance B of the facial area can be set to the target mean luminance. Setting a targeted mean luminance in this manner makes it possible to make brightness of the targeted area (specified area) substantially uniform despite different photographic conditions.

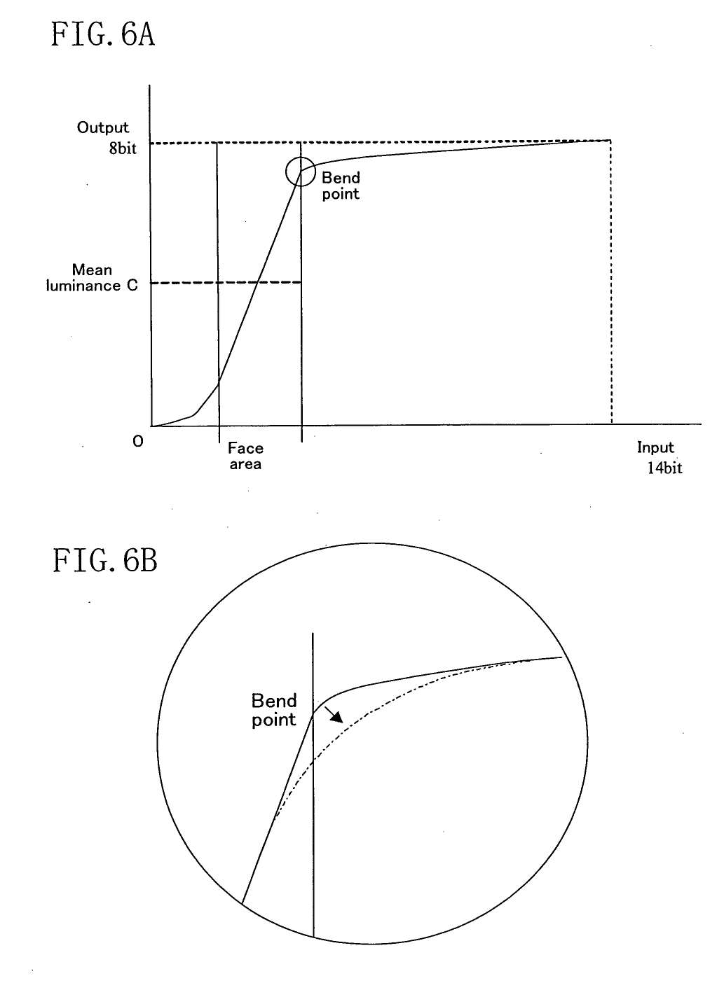

Further, if the gradation assignment curve is no longer smooth due to the gradation assignment, gain adjustment and the like, in order to prevent effects at a bend point from appearing significantly in images, the bend point may be approximated to a non-linear curve as shown in FIG. 6, thereby eliminating the effects at the bend point.

Furthermore, when adding an offset, it is presumed that an addition of an offset only to the specified area (facial area) may result in unnaturalness since continuity to peripheral image areas is lost. The gradation assignment curve of FIG. 5 may be applied to the gradation of the periphery of the offset area to eliminate unnaturalness.

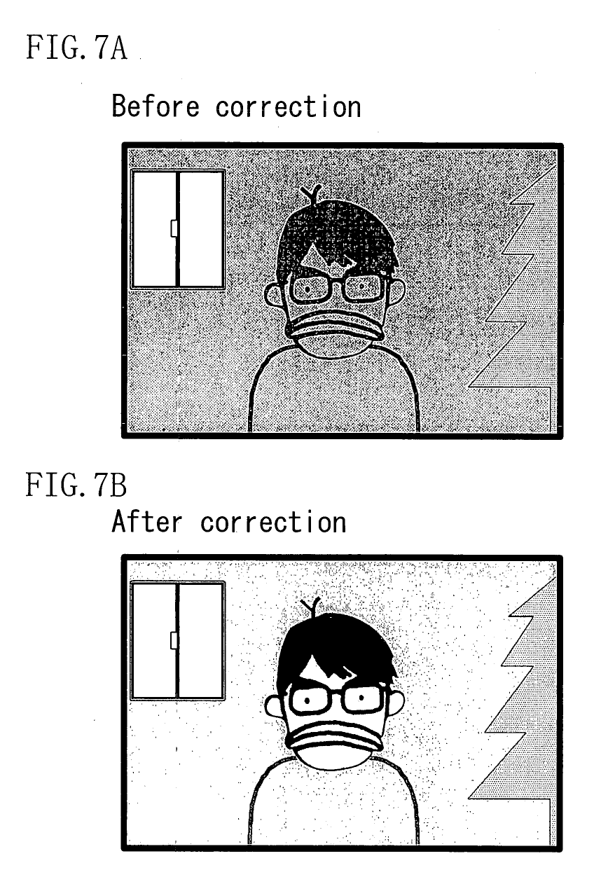

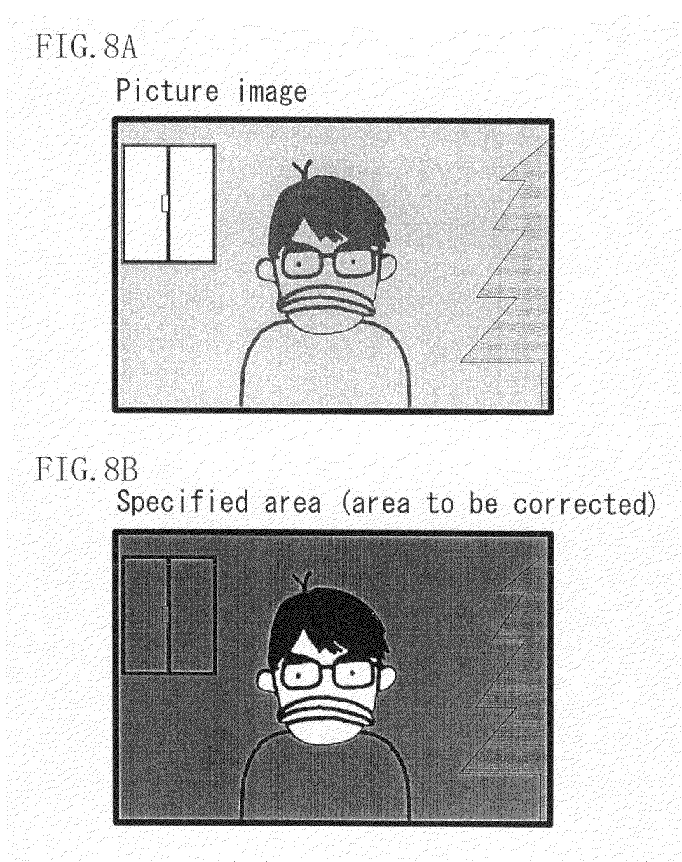

FIG. 7 shows an example of an image prior to correction in (a) and an image after the correction in (b). Further, FIG. 8 shows a diagram indicating that only the facial portion is the subject of the specified area by the facial correction operation of the area detection portion 7. Since only the facial portion is recognized from the shot image shown in FIG. 8A and the recognized facial portion is subject to correction, it is observed that only the facial portion is subject to correction as shown in FIG. 8B. By performing correction of the area of FIG. 8B, the facial portion of the photographic subject is dark in FIG. 7A. However, as shown in FIG. 7B, it is observed that after the correction, only the facial portion has been corrected to be bright and clear.

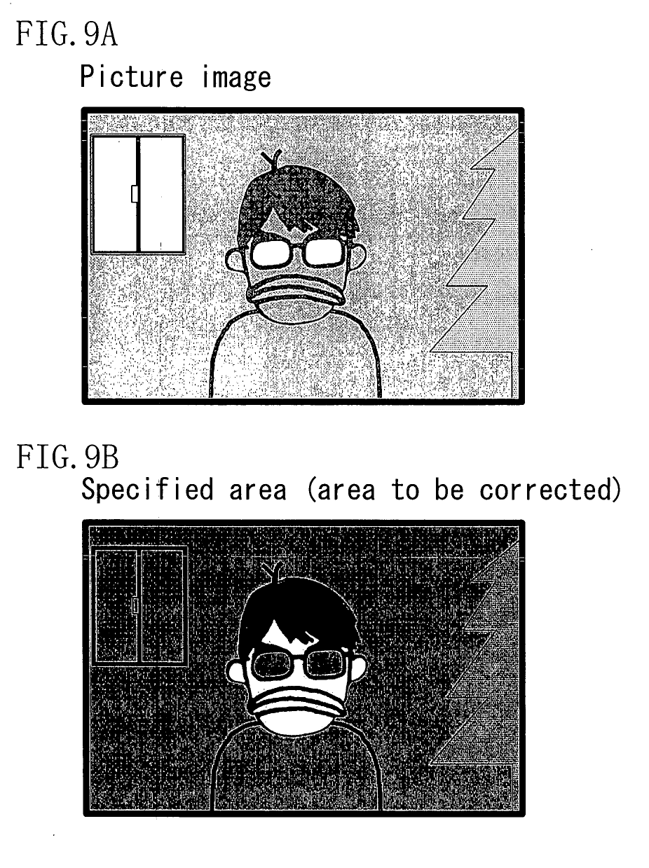

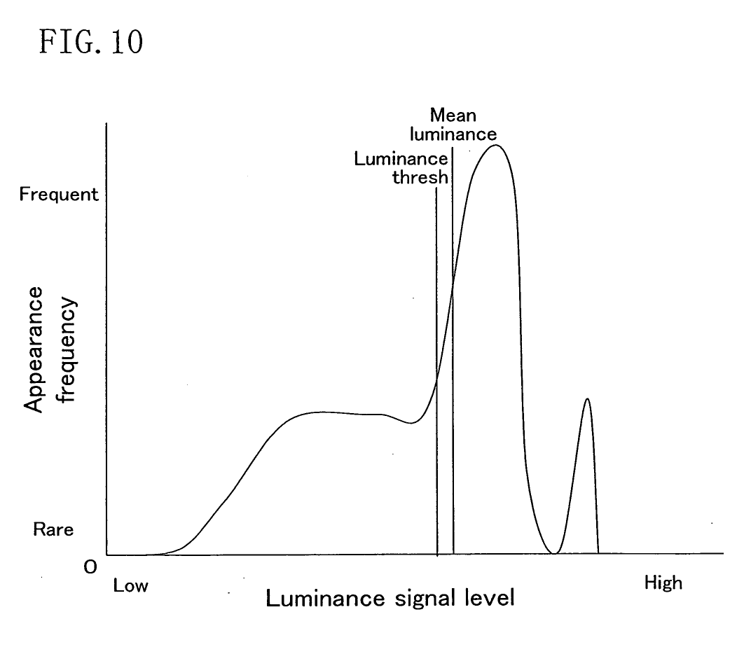

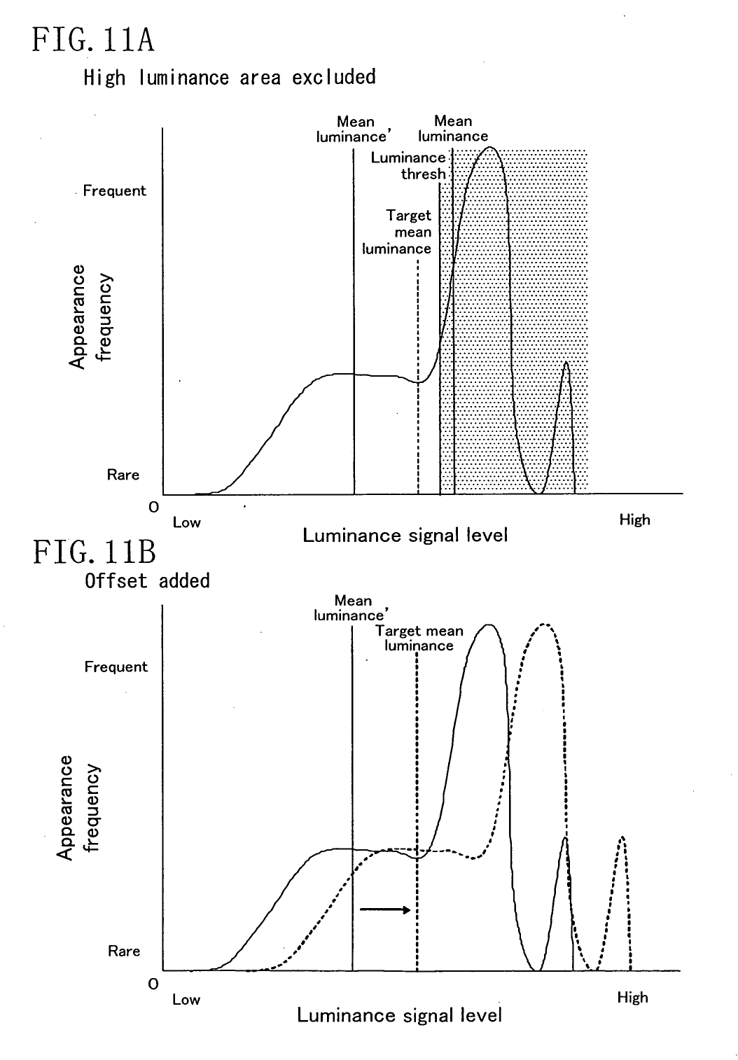

Further, a luminance signal threshold value may be set so that the luminance signal detection portion 9 conducts a detection operation only to a portion where out of the luminance signals in the specified area (facial area and the like), the luminance signal does not surpass the luminance signal threshold value. An image concept diagram of this instance is shown in FIG. 9. FIG. 9A is an image prior to the correction and FIG. 9B shows an area subject to the correction. In FIG. 9A, the overall image is bright, and the mean luminance of the facial portion, which is the specified area at that time, increased due to reflection of the eye glasses. However, since, by setting the luminance signal threshold value, a portion of a high luminance signal level (portion of the eye glasses herein) is excluded from the scope of the area subject to the correction. Thus, as shown in FIG. 9A, area of the facial portion other than the eye glasses is subject to correction. A schematic diagram of the luminance signal threshold value is shown in FIG. 10. As shown in FIG. 10, the mean luminance inside the specified area is high, if the correction is carried out as it is, the correction proceeds toward lowering the mean luminance of the overall face, which disables proper correction. In view of this, if no observation is made of luminance signals above the luminance thresh, which is the luminance signal threshold value, then as shown in FIG. 11A, the mean luminance becomes a mean luminance′. Further, by adding an offset to the video signal RAW1, as shown in FIG. 11B, the mean luminance′ can be brought to the target mean luminance. This makes it possible to prevent the face from becoming dark because of an increase in the mean luminance of the facial area through reflection of the eye glasses and the like and causing the face to darken due to the correction.

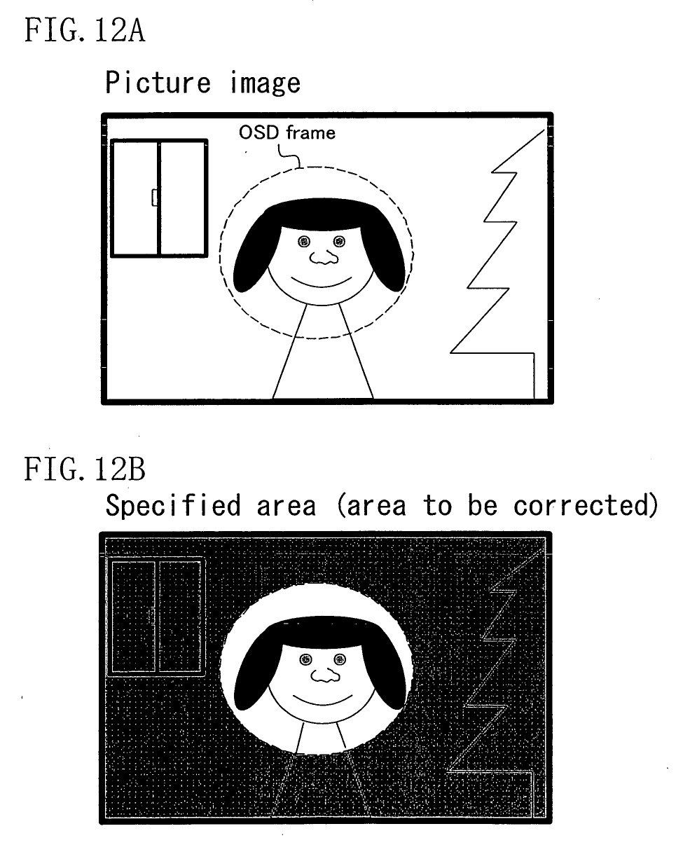

Still further, it may also be acceptable to overlap the specified area on the OSD in the form of a frame (OSD frame) indicating the specified area as shown in, for example, FIG. 12A, and to display it on the display device 6. This enables the photographer to know the area to correct at the time of shooting as shown in FIG. 12B by incorporating in this OSD frame a photographic subject whose gradation and mean luminance are sought to be secured by the photographer when the photographer shoots.

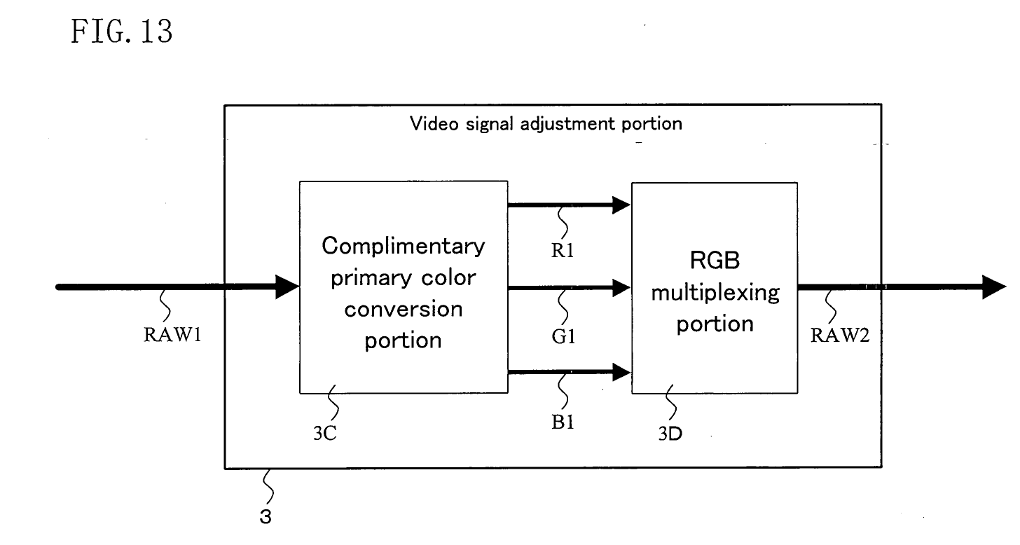

At this point, if the video signal RAW1 which the imaging device 2 outputs is in complimentary colors (Ye, Cy, Mg, and G), then as shown in FIG. 13, by configuring the video signal adjustment portion 3 to include a complimentary primary color conversion portion 3C for converting a complimentary color to a primary color and an RGB multiplexing portion 3D for subjecting color information (R1, G1, and B1) that the complimentary primary color conversion portion 3C outputs to multiplexing to convert the information to the adjusted video signal RAW2, it is possible to cope without affecting processing blocks succeeding the video signal adjustment portion 3. When converting a complimentary color to a primary color, for example, complimentary color data is expressed by Ye=R+G, Cy=B+G, Mg=R+B, and G, and since out of one Ye data, two data of R data and G data are simultaneously generated, color information of R data R1, G data G1, and B data B1 is subjected to multiplexing in the RGB multiplexing portion 3D and outputted to the image data conversion portion 4. In this manner, coping with changes in video signals accompanying changes in the imaging device 2 may be carried out.

### Second Embodiment

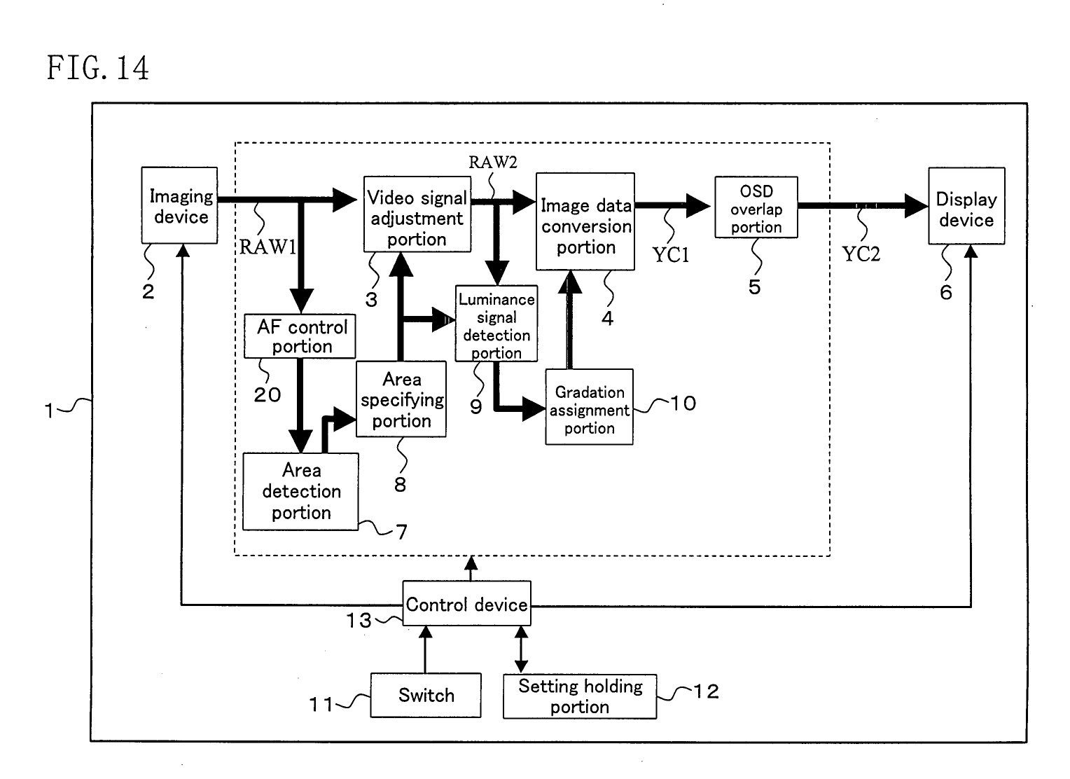

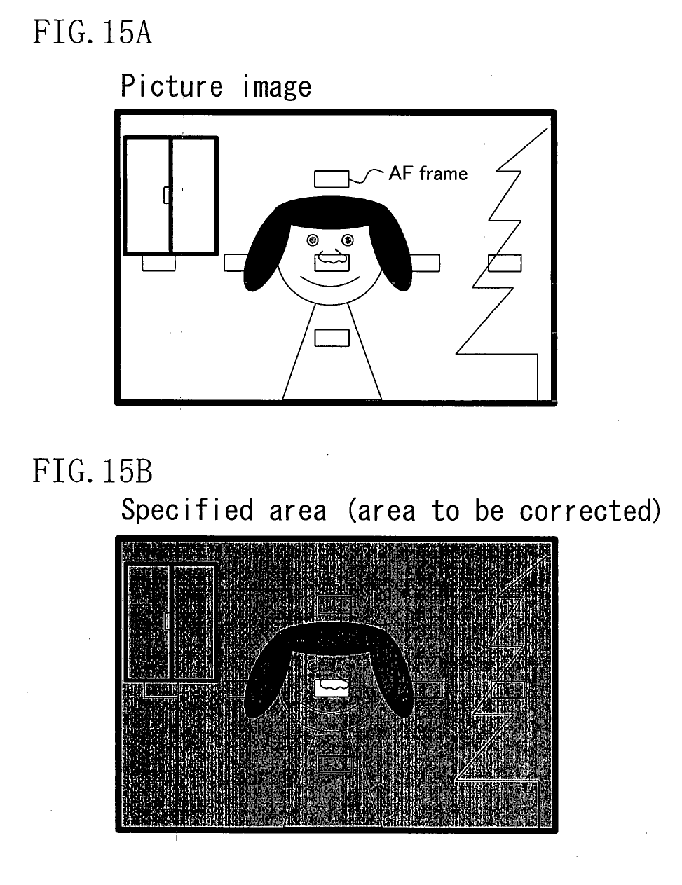

A construction of a digital camera according to a second embodiment is shown in FIG. 14. This digital camera 1 is further provided with an AF (Auto-Focus) control portion 20 in addition to the elements of construction shown in FIG. 1. The AF control portion 20 carries out control of focusing on the photographic subject. A picture image and the correction area in the digital camera 1 of the present embodiment are shown in FIG. 15.

Normally, when performing AF control, there are several AF areas (focus areas) to focus on. In this case, seven square frames (AF frames) in FIG. 15A correspond to the AF areas. If the AF areas are selected at this point as the specified areas, as in FIG. 15B, an image in the AF areas in focus is subjected to correction as an area to be corrected. Normally, since a focus is made on the area of the photographic subject, if the AF area is set as the specified area, it is possible to save the trouble of specifying the area to be corrected in advance.

### Third Embodiment

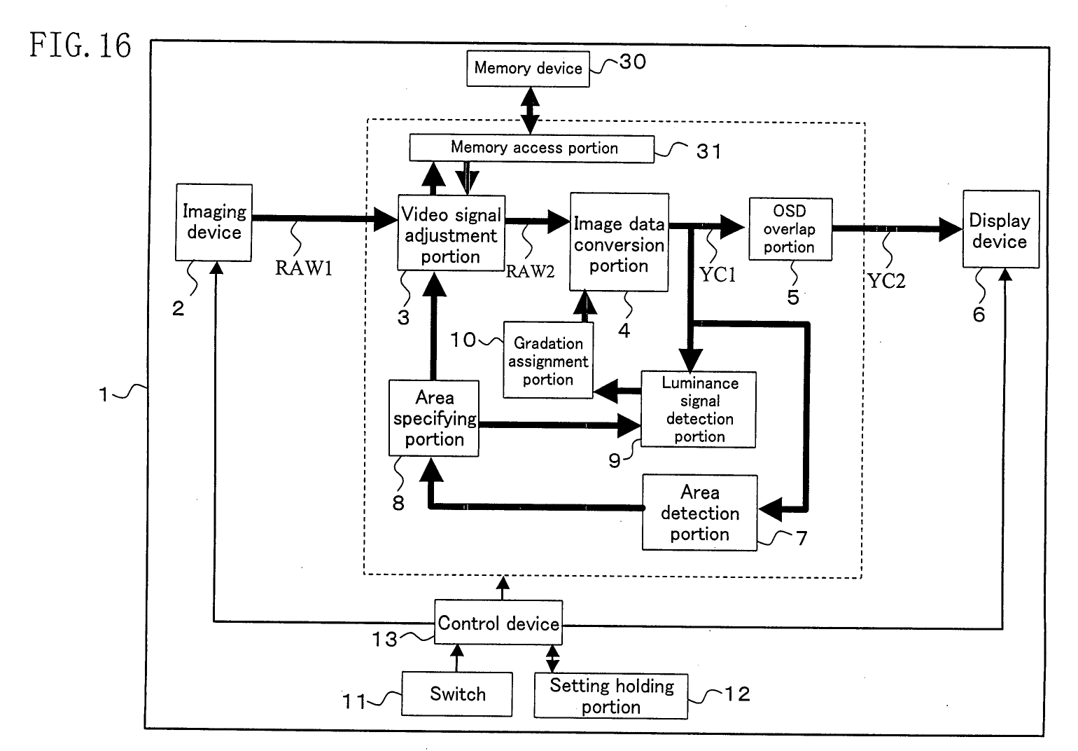

A construction of a digital camera according to a third embodiment is shown in FIG. 16. This digital camera 1 is further provided with a memory device 30 for storing image signals and the like and a memory access portion 31 for storing a video signal in or taking it out of the memory device 30 in addition to the elements of construction shown in FIG. 1. Further, the image data conversion portion 4 converts a video signal from the memory access portion 31 into image data. The control device 13 controls each processing portion so as to repeat generating the image data from the video signal until the luminance signal of the area (mean luminance, maximum luminance, minimum luminance and the like) specified by the area specifying portion 8 reaches a preset value.

Even in the case where exposure time change and gain adjustment cannot be performed in the imaging device 2 with respect to an image whose axis of time is shifted, such as correcting an image at an instant the shutter is pressed, since the memory access portion 31 stores the video signal RAW1 in and takes it out of the memory device 30, by loading the video signal RAW1 once on the memory device 30, the image data YC1 can be generated as often as desired with respect to the same video signal RAW1. Consequently, it is possible to approach the target image data closer.

### Other Embodiments

It should be noted that the present invention is not confined to the above-mentioned embodiments but may be implemented as follows.

(1) In the above-mentioned embodiment, the formulas Ye=R+G, Cy=B+G, Mg=R+B, and G, are used for conversion from a complimentary color to a primary color. But it is not limited to this. For conversion, coefficients a to f may be used such as Ye=aR+bG, Cy=cB+dG, Mg=eR+fB, and G.

(2) In the above-mentioned embodiment, overlap data OSD1 overlaps the image data YC1, but a value of the image data YC1 itself may be adjusted.

(3) In the above-mentioned embodiment, area recognition is made from the image data YC1 in facial recognition and flesh-color recognition. However, area recognition may be performed from the video signals RAW1 and RAW2.

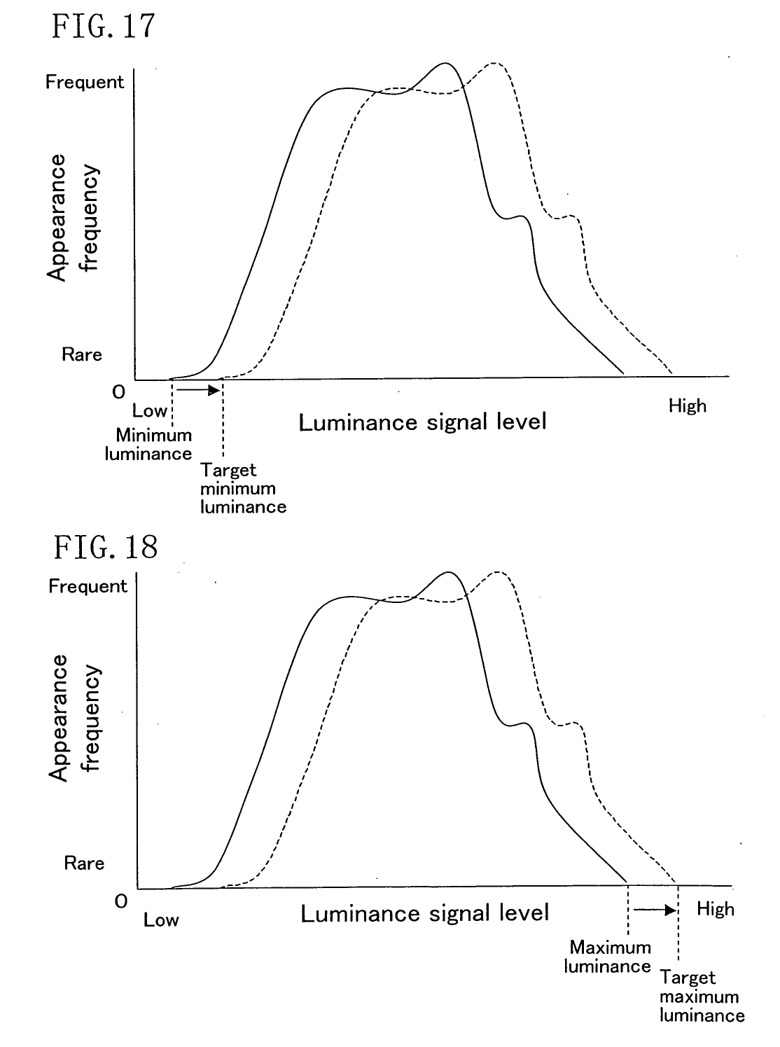

(4) In the above-mentioned embodiment, offset adjustment and the like are performed with respect to the target mean luminance. However, as shown in FIG. 17 and FIG. 18, correction may be made so that target values are met with respect to the minimum luminance and the maximum luminance.

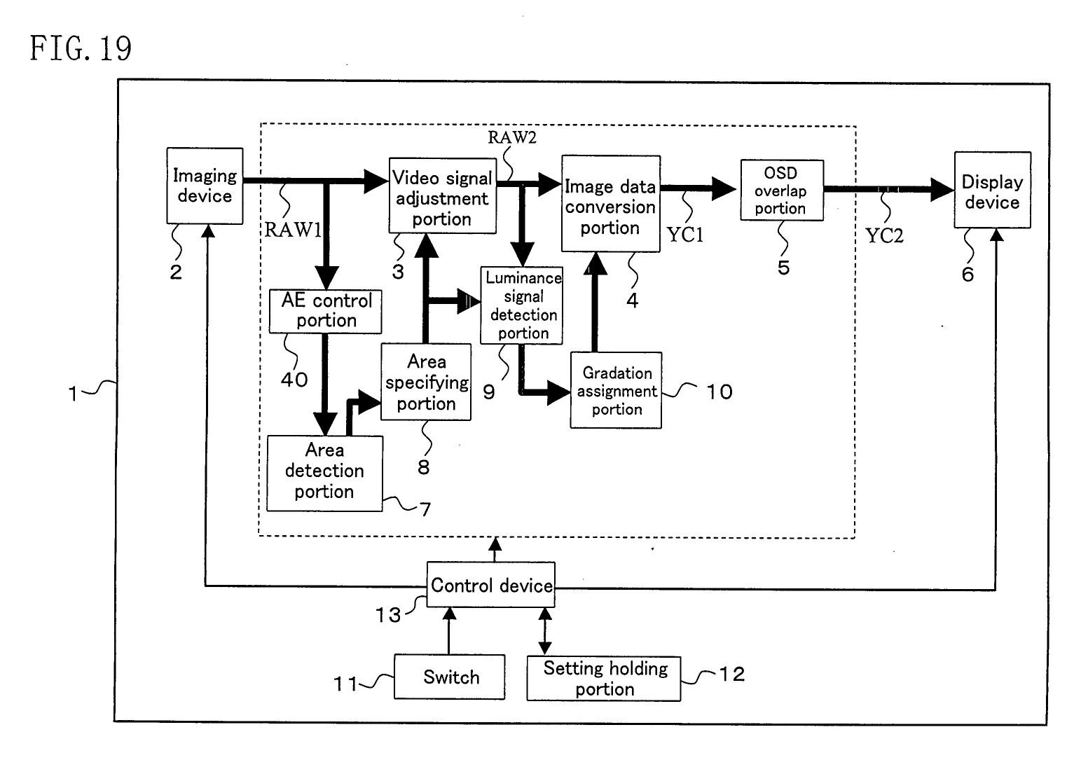

(5) In the above-mentioned embodiments, there is described an example of providing the AF control portion 20 which performs AF control. In lieu of this, as shown in FIG. 19, it is acceptable to provide an AE (Auto-Exposure) control portion 40 which by generating a luminance component from the video signal and measuring light, automatically sets proper exposure in the imaging device 2 through the control device 13 and to set, as the specified area, the AE area whose light was measured by the AE control portion 40.

(6) In the above-mentioned embodiments, the mean luminance of the luminance signal is adjusted through offsetting by the video signal adjustment portion 3. However, it is acceptable to adjust the mean luminance by adjusting exposure time and gain in the imaging device 2.

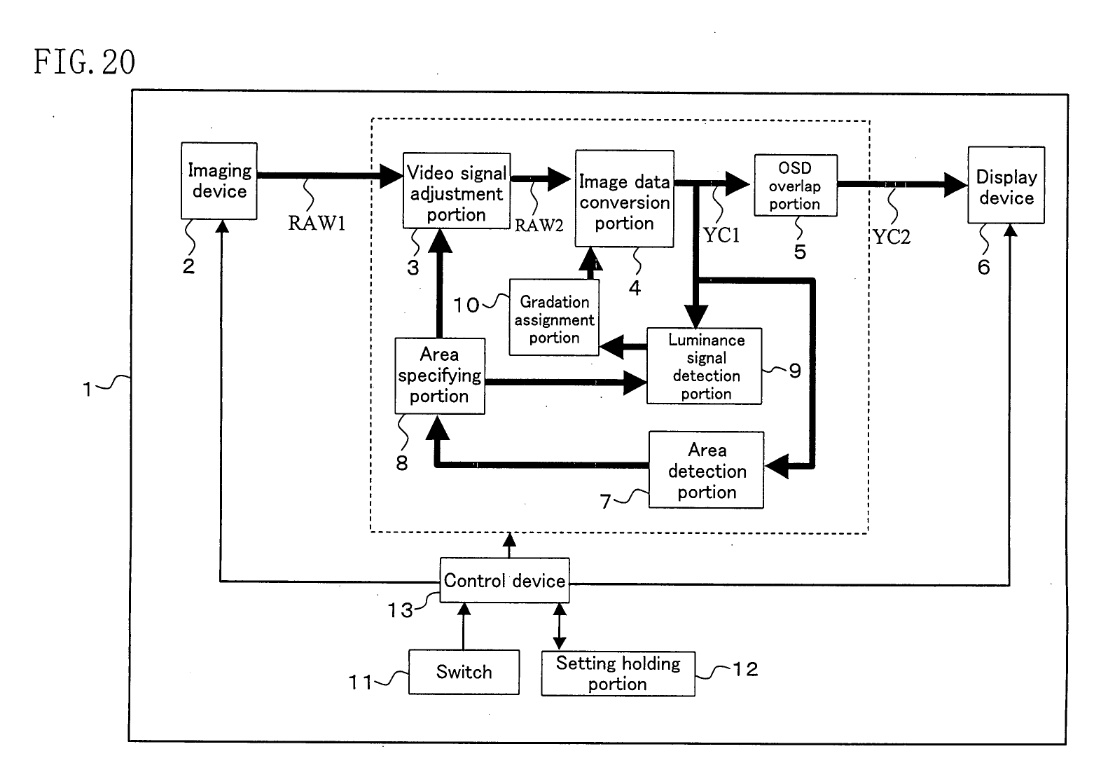

(7) In the above-mentioned embodiments, luminance signal detection is performed with respect to the adjusted video signal RAW2. However, as shown in FIG. 20, this may be performed with respect to the image data YC1.

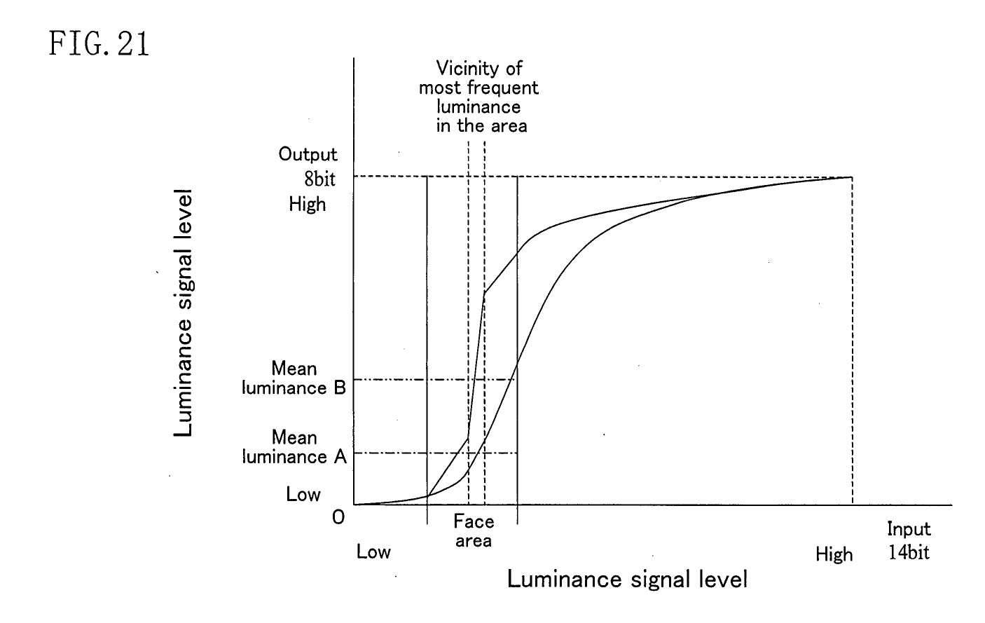

(8) In the above-mentioned embodiment, correction is made linearly in changing gradation assignment in FIG. 4. However, as shown in FIG. 21, gradation assignment may be changed such that much gradation may be assigned with respect to the vicinity of the maximum appearance luminance from the frequency of luminance appearance in the specified area.

### INDUSTRIAL APPLICABILITY

According to the digital camera of the present invention, the luminance level of a face (specified area) is made constant regardless of photographic conditions, thus facilitating to compare photographic subjects (e.g., faces and upper body halves). Further, when performing gain control, maintaining gradation in the vicinity of a face contributes to keeping the high-definition of the face and improving the recognition of the face. Furthermore, by showing a frame of the face through OSD, placing the face in the frame, and shooting it, it is possible to take a picture of a face in a preset size regardless of the size of a person's face or photographic conditions. Moreover, it is made easier to compare photographic subjects. From the foregoing, when making an album or a list using facial photos, shooting and performing image processing so as to obtain uniform levels of luminance (brightness) and gradation makes it possible to improve visibility.

What is claimed is:

1. A digital camera comprising:
an imaging device having a function to control a quantity of transmitted light of an imaging optical system and a function to subject the transmitted light to photoelectric conversion to generate a video signal;
an area specifying portion specifying an area to control;
an image data conversion portion converting the video signal generated by the imaging device to image data including a luminance signal and a color difference signal and outputting the image data;
a luminance signal detection portion detecting the luminance signal from the video signal or the image data;
a gradation assignment portion giving an instruction to the image data conversion portion on assignment of gradation based on information detected by the luminance signal detection portion; and
a control device controlling the imaging device, the area specifying portion, the gradation assignment portion, the image data conversion portion, and the luminance signal detection portion, wherein the image data conversion portion performs the conversion based on the instruction on assignment of gradation from the gradation assignment portion.

2. The digital camera according to claim 1, wherein the video signal is any one of a primary color signal (R, G, B), a complimentary color signal (Ye, Cy, Mg, G), and a luminance signal and a color difference signal (Y, Cb, Cr).

3. The digital camera according to claim 1, further comprising a video signal adjustment portion adjusting the video signal and outputting the video signal as an adjusted video signal to the image data conversion portion.

4. The digital camera according to claim 1, wherein:
the luminance signal detection portion calculates a mean luminance of the area specified by the area specifying portion; and
the gradation assignment portion gives an instruction on assignment of the gradation to the image data conversion portion so as to make the mean luminance constant.

5. The digital camera according to claim 1, wherein:
the luminance signal detection portion calculates a maximum luminance of the area specified by the area specifying portion; and
the gradation assignment portion gives an instruction on assignment of gradation to the image data conversion portion so as to make the maximum luminance constant.

6. The digital camera according to claim 1, wherein:
the luminance signal detection portion calculates a minimum luminance of the area specified by the area specifying portion; and
the gradation assignment portion gives an instruction on assignment of gradation to the image data conversion portion so as to make the minimum luminance constant.

7. The digital camera according to claim 1, wherein:
the luminance signal detection portion calculates a frequency distribution of luminance signal levels of the area specified by the area specifying portion; and
the gradation assignment portion gives an instruction on assignment of gradation to the image data conversion portion so as to assign much gradation in a vicinity of a luminance signal level of highest frequency of appearance of the specified area.

8. The digital camera according to claim 1 further comprising an area detection portion detecting a face of a photographic subject from the video signal or the image data, wherein the area specifying portion specifies an area of the face detected by the area detection portion.

9. The digital camera according to claim 8, wherein the area specifying portion specifies at least one area of a cheek or a forehead out of the area of the face detected by the area detection portion.

10. The digital camera according to claim 1, further comprising an area detection portion detecting a flesh color, wherein the area specifying portion specifies an area of the flesh color detected by the area detection portion.

11. The digital camera according to claim 1, further comprising an AF (Auto-Focus) control portion automatically setting a focus to the imaging device based on a frequency component of the video signal, wherein the area specifying portion specifies an AF area (Focus Area) focus-locked by the AF control portion.

12. The digital camera according to claim 1, further comprising an AE (Auto-Exposure) control portion automatically setting a proper exposure to the imaging device by generating a luminance component from the video signal and measuring light, wherein the area specifying portion specifies the AE area where light was measured by the AE control portion.

13. The digital camera according to claim 1, wherein the luminance signal detection portion performs detection operation with respect to a luminance signal not exceeding a preset luminance signal threshold value in the area specified by the area specifying portion.

14. The digital camera according to claim 1, further comprising a switch capable of being set externally, wherein the gradation assignment portion enables a level of the luminance signal to be changed by the switch.

15. The digital camera according to claim 1, further comprising a switch capable of being set externally, wherein the gradation assignment portion enables a ratio of gradation assignment to be changed by the switch.

16. The digital camera according to claim 1, further comprising:
a setting holding portion; and
a switch for selecting a shooting mode, wherein upon switching of the shooting mode by the switch, the control device reads a prior setting of the switched shooting mode from the setting holding portion.

17. The digital camera according to claim 1, wherein the gradation assignment portion assigns much gradation with respect to a range in which luminance is distributed in the area specified by the area specifying portion.

18. The digital camera according to claim 1, wherein the gradation assignment portion changes the gradation only in the area specified by the area specifying portion.

19. The digital camera according to claim 18, further comprising a nonlinear characteristic portion generating nonlinear characteristic information, wherein the gradation assignment portion, based on information from the nonlinear characteristic portion, changes gradation on a boundary part of the specified area in such a way as to shift smoothly in terms of nonlinear characteristic.

20. The digital camera according to claim 1, further comprising:
a memory device storing the video signal generated by the imaging device;
a memory access portion storing the video signal in or taking the video signal out of the memory device; and
a video signal adjustment portion adjusting the video signal taken out of the memory access portion and outputting the video signal as an adjusted video signal to the image data conversion portion, wherein:
the image data conversion portion converts the adjusted video signal to image data including a luminance signal and a color difference signal and outputs the image data; and
the control device controls each of the processing portions such that the processing to generate the image data from the video signal taken out of the memory access portion is repeated until the luminance signal of the area specified by the area specifying portion reaches a preset value.

21. The digital camera according to claim 1, further comprising:
an OSD overlap portion outputting display data having an OSD overlap signal overlapped on the image data; and
a display device displaying the display data.

22. The digital camera according to claim 21, wherein:
the OSD overlap signal is frame data; and
the area specifying portion specifies an area surrounded by the frame data.
